(19) United States
(12) Patent Application Publication
(10) Pub. No.: US 2022/0284238 A1
(43) Pub. Date: Sep. 8, 2022

(54) LEARNING APPARATUS, METHOD AND PROGRAM

(71) Applicant: KABUSHIKI KAISHA TOSHIBA, Tokyo (JP)

(72) Inventors: Shuhei NITTA, Tokyo (JP); Akiyuki TANIZAWA, Kawasaki Kanagawa (JP)

(73) Assignee: KABUSHIKI KAISHA TOSHIBA, Tokyo (JP)

(21) Appl. No.: 17/461,082

(22) Filed: Aug. 30, 2021

(30) Foreign Application Priority Data
Mar. 5, 2021 (JP) 2021-035666

(51) Int. Cl. G06K 9/62; G06T 3/40; G06N 3/04

(52) U.S. Cl. CPC G06K 9/6256; G06T 3/4046; G06N 3/04

(57) ABSTRACT

According to one embodiment, a learning apparatus includes a processor. The processor determines, based on a data resolution of subject data obtained at a subject device, a plurality of data resolutions that differ from one another within a range covering the data resolution of the subject data, the data resolutions each indicating a corresponding amount of information per unit. The processor trains a scalable network with training samples corresponding to each of the plurality of data resolutions, the scalable network being a neural network adapted to change a data resolution of input data.

### CROSS-REFERENCE TO RELATED APPLICATIONS

This application is based upon and claims the benefit of priority from Japanese Patent Application No. 2021-035656, filed Mar. 5, 2021, the entire contents of which are incorporated herein by reference.

### FIELD

Embodiments described herein relate generally to a learning apparatus, method and program.

### BACKGROUND

A technique called neural architecture search (NAS) for optimizing the architecture design of a neural network is gathering attention. For example, the technique includes training a scalable neural network using a s combination of multiple conditions for the size of input images, the number of layers, and the number of channels.

This technique, however, does not have applicable guidelines for the variation on which a training process should be based, and as such, does not allow for easy selection and setting of this variation. Also, the inference accuracy obtained by the technique is often insufficient, as the training process proceeds without specifically assuming use in a subject device.

### BRIEF DESCRIPTION OF THE DRAWINGS

FIG. 1 is a block diagram showing a learning apparatus according to an embodiment.

FIG. 2A is a conceptual diagram showing data resolutions of image data according to the embodiment.

FIG. 2B is a conceptual diagram showing data resolutions of time-series data according to the embodiment.

FIG. 3 is a flowchart showing an exemplary operation of the learning apparatus according to the embodiment.

FIG. 4 is a conceptual diagram of a residual block.

FIG. 5 is a conceptual diagram showing a layer structure of a scalable network as a basic structure.

FIG. 6 is a conceptual diagram showing, in contrast to the basic structure, a layer structure of the scalable network for a smaller image size.

FIG. 7 is conceptual diagram including results of simulation with the learning apparatus according to the embodiment.

FIG. 8 is a diagram showing a hardware configuration of the learning apparatus according to the embodiment.

### DETAILED DESCRIPTION

In general, according to one embodiment, a learning apparatus includes a processor. The processor determines, based on a data resolution of subject data obtained at a subject device, a plurality of data resolutions that differ from on another within a range covering the data resolution of the subject data, the data resolutions each indicating a corresponding amount of information per unit. The processor trains a. scalable network with training samples corresponding to each of the plurality of data resolutions, the scalable network being a neural network adapted to change a data resolution of input data.

The learning apparatus, method and program according to embodiments will be described in detail with reference to the drawings. The description will assume the components or elements having the same reference signs to operate in the same manner, and redundant explanations will be omitted as appropriate.

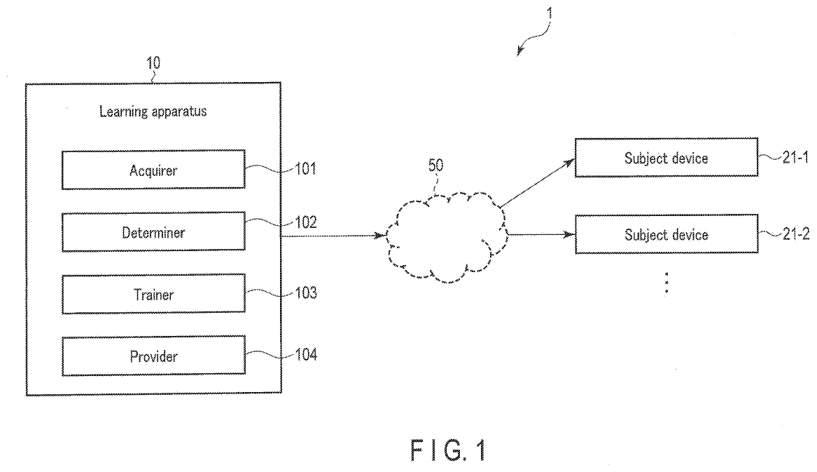

A block diagram in FIG. 1 will be referred to for explaining a model providing system that embraces the learning apparatus according to one embodiment.

In one embodiment, a model providing system 1 includes a learning apparatus 10 and one or more subject devices 21.

The learning apparatus 10 may establish connections to the subject devices 21-1 and 21-2 via a network 50. The subject devices 21 here are assumed to be so-called “edge devices” adapted to load and run a trained model for intended processing. Each subject device 21 may be, for example, a street or factory surveillance camera, an Internet of things (IoT) device of a user, or the like.

Note that while FIG. 1 shows two subject devices 21, the number of the subject devices 21 may be one, or three or more. Unless otherwise specified, the description will assume instances where the model providing system 1 includes only one subject device 21, or multiple subject devices 21 of the same specifications.

The learning apparatus 10 according to the embodiment includes an acquirer 101, a determiner 102, a trainer 103, and a provider 104.

The acquirer 101 acquires device information of the subject device 21 as an intended recipient of a trained model.

Examples of the device information are a data resolution of subject data obtained at the subject device 21 (which may also be called a “subject data resolution”), processing ability of the processing circuitry (e.g., a central processing unit (CPU), a graphics processing unit (GPU), a field programmable gate array (FPGA), an application specific integrated circuit (ASIC), etc.) of the subject device 21, a maximum device memory, and so on. As the subject data, a variety of data may be used including image data taken by a camera, time-series data such as a voice collected by a microphone, and so on. The data resolution indicates the amount of information per unit. The information on the processing ability of the processing circuitry may take the form of floating-point operations per second (FLOPS), trillion operations per second (TOPS), etc.

The acquirer 101 also acquires training samples and target data for training a machine learning model. A set of one or more training samples and one or more target data items may be called a “training data set”.

The determiner 102 receives the device information from the acquirer 101 and determines, based on the subject data resolution contained in the device information as a baseline, multiple data resolutions that differ from one another within a range covering the subject data resolution.

The trainer 103 receives the training data set from the acquirer 101 and information for the mutually different multiple data resolutions from the determiner 102. The trainer 103 trains a scalable network to generate a trained model using the training data set containing the training samples corresponding to the respective ones of the different data resolutions. The scalable network here is a neural network which can change at least the data resolution (size) of input data.

The provider 104 receives the trained model from the trainer 103 and provides it to the subject device or devices 21 via the network 50. Note that the routing via the network 50 is optional, and the learning apparatus 10 may directly provide the trained model to the subject devices 21 through wired or wireless connection to the subject devices 21.

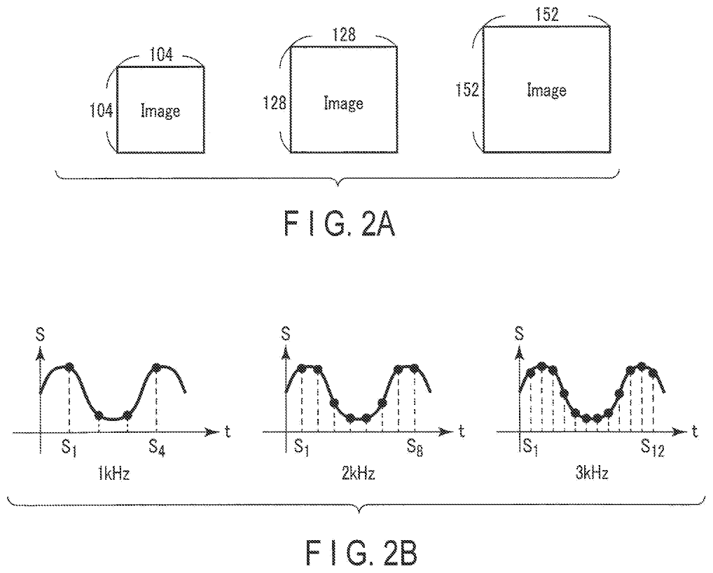

Next, FIGS. 2A and 2B will be referred to for explaining the concept of data resolutions according to the embodiment.

FIG. 2A shows the concept of multiple data resolutions in the instances where the subject data is image data. When the subject data is image data, an image size is the data resolution, and the resolution of the image data can be changed by altering the vertical and horizontal sizes (pixel numbers) of “one image” as a unit. In FIG. 2A, three different image sizes are shown, namely, a size of 104×104 [pixel], a size of 128×128 [pixel], and a size of 152×152 [pixel]. In general, image data has a high resolution when its pixel number is large, and image data has a low resolution when its pixel number is small.

FIG. 2B shows the concept of multiple data resolutions in the instances where the subject data is time-series data. When the subject data is time-series data such as a voice or a sensor value, a sampling rate of the data is the data resolution. As shown in FIG. 2B, the resolution of the time-series data can be changed by altering the sampling intervals for the time-series data per unit time. In FIG. 2B, three different sampling rates for time-series data are shown, namely, a 1 kHz sampling rate with 4 sampling points (S₁ to S₄) in unit time, a 2 kHz sampling rate with 8 sampling points (S₁ to S₈) in unit time, and a 3 kHz sampling rate with 12 sampling points (S₁ to S₁₂) in unit time. When the sampling rate is high, the number of data acquired in unit time is large, and therefore, the data resolution is high. When the sampling rate is low, the number of data acquired in unit time is small, and therefore, the data resolution is low.

The determiner 102 may determine multiple data resolutions that differ from one another, as shown in FIGS. 2A and 2B. The description of the embodiments will assume exemplary instances in which the subject data is image data and the data resolutions are image sizes.

However, the embodiment does not limit the subject data to image data and time-series data. Any data may be adopted as the subject data, provided that such data has been sampled at equal intervals to allow for the determination of its data resolution.

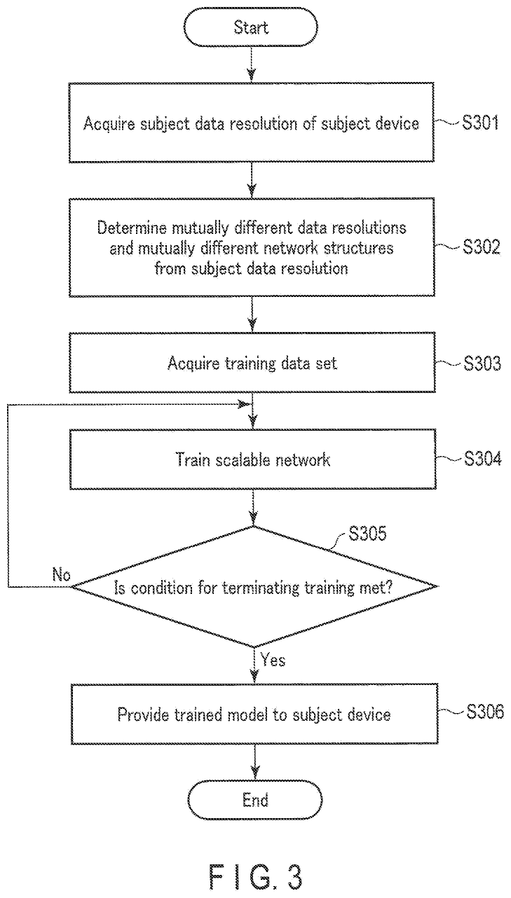

Next, an exemplary operation of the learning apparatus 10 according to one embodiment will be described with reference to FIG. 3 as a flowchart. Note that FIG. 3 assumes an exemplary case in which a trained model for executing an image classification task of determining whether or not an image shows a car is provided and loaded on a street surveillance camera as the subject device 21. It will also be assumed that, in this exemplary case, the trained model is generated through a training process on a scalable network which is adapted to change the size of input, data and the number of network layers (which may also be called “layer number”).

In step S301, the acquirer 101 acquires device information of the subject device 21 to acquire the subject data resolution for the subject device 21. That is, the acquirer 101 acquires the baseline image size of image data. By way of example, in this example, the size of an image obtained at the subject device 21 is assumed to be 128×128 [pixel].

In step S302, the determiner 102 determines, based on the subject data resolution acquired in step S301, mutually different multiple data resolutions and also mutually different multiple network structures for the scalable network. That is, the determiner 102 determines multiple data resolutions that differ from one another within a range covering the baseline image size obtained at the subject device 21, and also determines multiple corresponding network structures. This example assumes a residual network (ResNet) as one example pertaining to such a network structure. The assumed ResNet is a convolutional neural network constituted by (6n+1) convolutional layers, where n is an integer equal to or greater than 1, and one fully connected layer. By changing the number n, the total number of layers corresponding to a calculation cost and the accuracy of inference (e.g., Accuracy) can be adjusted. If, for example, n is set to 6, then the network structure has (6×6+1)+1=38 layers. In the description of the embodiments, the network structure of a scalable network that corresponds to the subject data resolution may also be called a “basic structure”. The scalable network of this basic structure is eventually provided to the subject device 21.

Note that the embodiment does not limit the type of the neural network to a ResNet. The embodiment may adopt any type of neural network, such as a DenseNet or a U-net having a shortcut structure, or a widely used deep convolutional neural network (DCNN), provided that such a neural network copes with the design of multiple network structures corresponding to different data resolutions.

The determiner 102 selects various values of n by increasing and decreasing a center value of n for the basic structure, and determines network structures corresponding to these multiple values of n, respectively. More specifically, the largest n value is selected within the capacity of the maximum memory of the subject device 21, which has been informed through the device information. The value n=6 serves as the center value. The ResNet structure corresponding to the center value is adopted as the basic structure, and five values of n are selected according to the center value of n for the basic structure and also based on n±1 and n±2. The determiner 102 determines the network structures corresponding to the respective values of n={4, 5, 6, 7, 8}.

The determiner 102 determines multiple image sizes corresponding to the layer numbers of the determined network structures, respectively. As for how to determine the image sizes, note, for example, that in the scalable network assumed by one embodiment, an increment of n by 1 entails an increase in layer number by 6 in the network as a whole. Hypothetically, when the stride of a kernel for the convolutional processing is set to 1, an increase by one layer entails an increase by 2 [pixel] of the receptive field of the convolutional layers in the scalable network as a whole. Thus, according to a simple conversion that does not take pooling into account, an increase in layer number by 6 would result in an increase by 12 [pixel] of the receptive field. As such, the determiner 102 may determine each image size that can cancel out a change in layer number so that the receptive field of the corresponding network structure is kept unchanged. In more concrete terms, when the baseline image size at the subject device 21 that corresponds to the basic structure is 128×128 [pixel], the image sizes corresponding to the layer numbers defined by n={4, 5, 6, 7, 8} are S={104, 116, 128, 140, 152}, respectively. Here, S indicates the number of pixels constituting one side of an image. Therefore, for example, the case of S=128 indicates an image size of 128×128 [pixel].

In step S303, the acquirer acquires a training data set to be used for training the scalable network and containing training samples corresponding to the mutually-different data sizes. Here, the training sample (image data) contained in the training data set is represented by x\vec{ }ᵢⱼ. The superscript arrow indicates a vector set. Symbol i is a serial number for the training samples, and it may be i={1, 2, . . . , B}, where B is the number of the acquired training samples. Symbol j is a serial number for combinations of the input image size and the layer number of the neural network, and it may be j={1, 2, . . . , M}, where M is the number of the combinations. That is, the training sample x\vec{ }ᵢⱼ is given as a vector of the pixel set for the i-th sample and the j-th combination of the image size and the layer number.

The example as shown in FIGS. 2A and 2B may use M=5, as five different layers are assumed. More concretely, the combinations intended here are (n=4, S=104) when j=1, (n=5, S=116) when j=2, (n=6, S=128) when j=3, (n=7, S=140) when j=4, and (n=8, S=152) when j=5.

For embodiments, the training samples x\vec{ }ᵢⱼ may be generated through a widely used image conversion process (such as the so-called “Resize”, “RandomCrop”, “CenterCrop”, or “RandomResizedCrop” technique, etc.). However, note that the relationship in resolution information should be maintained among the cases of j=1 to j=M. Thus, for example, it is possible to perform image conversion for only the case of j that provides the highest resolution, and subject the resultant image to the Resize processes to generate images for the other cases of j, so that the training samples that keep the relationship in resolution information can be generated. If a training data set containing training samples for various image sizes is ready, the data x\vec{ }ᵢⱼ may be directly selected without performing clipping or scale conversion processes.

The target data tᵢ contained in the training data set is a scaler value corresponding to a subject label. For example, if the i-th image shows a car, the target data tᵢ is “1”, and if not, it is “0”.

In step S304, the trainer 103 trains the scalable network, using the training data set where the training samples serve as input data and the target data serves as ground truth data. In other words, the neural network of a network structure that has been changed according to the image size undergoes its learning process with the training data set. One exemplary training method by the trainer 103 may be given by following expressions (1) to (3).

yᵢⱼ=f(w\vec{ }ⱼ, x\vec{ }ᵢⱼ) (1)

Lᵢⱼ=−tᵢ ln(yᵢⱼ+e)−(1−tᵢ)ln(1−yᵢⱼ+e) (2)

L=Σⱼ{aⱼΣLᵢⱼ} (3)

Here, x\vec{ }ᵢⱼ represents the training sample (image data) as an input to the neural network, and yᵢⱼ represents an output of the neural network, e.g., the probability of a car appearing in the image in this example.

Symbol f is a function of a neural network for retaining the parameter set w\vec{ }ⱼ. In a neural network, processes in the convolutional layers, fully connected layer, normalization layers, pooling layers, etc. are repeated. The scalable network changes its layer number according to the size of an input image, and the parameter number, etc. are therefore also changed according to the layer number. As such, the parameter set w\vec{ }ⱼ has, as an index, symbol j which is the combination of the input image size and the layer number of the neural network.

Note that the cases of w\vec{ }₁ and w\vec{ }₂ share parameters such as the weighting parameter and a bias for the fully connected layer, etc., other than the parameters for the layers increased according to the increment of n by 1.

For the normalization layer, statistical parameters such as an average parameter and a dispersion parameter are prepared for each value of j. That is, they may be set for each of the different image sizes. Also, they may be recalculated after the training. Since the parameters for the normalization layer account for only a small portion of the entire set of parameters, the weighting and biasing parameters for the normalization layer may be prepared for each value of j, that is, set for each of the different image sizes.

At the end of the function f, a sigmoid function corresponding to the output layer is included so that the value of the output yᵢⱼ is limited to a range of 0 to 1.

Expression (2) indicates calculation of a training loss Lᵢⱼ with the training sample x\vec{ }ᵢⱼ. Symbol tᵢ is target data serving as a label and given as a scaler value which is, for example, “1” if the i-th image shows an object such as a car, and “0” if no such object appears. In one embodiment, the training loss Lᵢⱼ is calculated using a binary cross entropy between the target data tᵢ and the output yᵢⱼ. Symbol ln is a natural logarithm, and e is a fixed value for preventing ln(0).

Expression (3) is a final loss function L that sums up the training losses Lᵢⱼ for i and j. Symbol aⱼ is an balancing parameter according to the value of j. In one embodiment, parameters of the neural network undergo iterative mini-batch training using back propagation and stochastic gradient descent, so as to minimize the loss function L that is based on the error calculated by weighted average of the training losses from the set of B×M samples. Here, the mini-batch training may be conducted by setting a batch size of the mini-batches to cover the samples having different image sizes for the same image data.

Note that the processing here is not limited to the mini-batch training for the training loss Lᵢⱼ from the target data tᵢ. For example, so-called “distillation” processing may be performed for the training about an error between two scalable networks having different network structures. In such instances, the iterative training may be conducted with the binary cross entropy between an output yᵢⱼ and another output y_{ij′} (j<j′) as an error.

In step S305, the trainer 103 determines whether or not a condition for terminating the iterative training is met. For example, it can be determined that the condition for terminating the iterative training is met if an index for the determination, such as an absolute value, decrement amount, or the like of the output training loss Lᵢⱼ or the output loss function L, is detected as being equal to or below a threshold. Or, the determination that the condition for terminating the iterative training has been met may be made if it is detected that the number of the iterations has reached a predetermined number.

Upon determining that the condition for terminating the iterative training is met, the training process is terminated. Upon determining that the condition is not met, the operation returns to step S304 to repeat the similar processing.

In step S306, the provider 104 provides the trained model generated through the training process to the subject device 21. More specifically, the subject device 21 is provided with the parameters for the neural network corresponding to the basic structure, so that the trained model corresponding to the basic structure is constructed at the subject device 21.

Note that while FIG. 3 has assumed an exemplary method where the basic structure of the scalable network is determined from the memory capacity of the subject device 21, the embodiments are not limited to this method.

For example, as a method for determining the basic structure of the scalable network, the device information containing FLOPS of the processing circuit mounted on the subject device 21 may be acquired so that the determiner 102 determines the basic structure according to the specification regarding the processing time, frame rate, etc. of the subject device 21. As a more concrete example, when the subject device 21 is adapted to take 10 images per one second, and each such image is to be subjected to the inference by a trained model, providing a trained model that can operate with a longest-possible inference time within the imaging frame rate (0.1 second per unit time) would realize the maximum inference accuracy for the specification of the subject device 21.

As another option, the determiner 102 may determine the basic structure according to the specification regarding the power consumption of the subject device 21. For example, when there is a demand that the subject device 21 loading and running the trained model for inference should consume no more than several tens of percent of the total power consumed during its operation, the determiner 102 may determine the basic structure of the scalable network according to a given power consumption value to meet this demand. Thus, the basic structure of the scalable network can be determined in this manner, based on the specification of the subject device 21 (regarding the memory capacity, processing time, frame rate, power consumption, and so on).

The foregoing description has assumed an order of processing in which the basic structure of the scalable network is determined based on the specification of the subject device 21, etc., multiple network structures of different layer numbers are determined, and then multiple different image sizes are determined based on the receptive fields of convolutional layers of the respective network structures. However, the embodiments are not limited to such an order. For example, multiple different image sizes may be determined first, and the basic structure of the network may be subsequently determined by performing back calculation from these image sizes to find out what receptive field would correspond to the comparable range. A receptive field indicates which area of the input image has been referenced, and as the depth of the layer increases, the referenced area of the input image becomes larger.

The method for determining the image sizes is not required to be based on the size of the entire image obtained at the subject device 21. If the scale or the like of an object is known from calculation, etc., multiple different image sizes may be determined based on the size of the object's image.

Here, for example, an image size corresponding to the area of the object may be specified from an entire image obtained by the subject device 21, using information such as the distance or spatial relationship between the object and the camera of the subject device 21, the actual size of the object, and a viewing angle of the camera.

If the scale of the object is calculated from the target data used in a separate trained model intended for a segmentation task or a regression task, the size of the object's image may be specified from this scale. Also, a bounding box, which is a region for object detection used by a trained model intended for an object detection task, may be referred to so that the size of the object's image is specified from the size of this bounding box. Further, a result of a lightly-supervised learning process that has used light annotations may also be used. For example, it is possible to use the result of a classification task together with a saliency map or class activation mapping (CAM) to calculate the size of the area of the object with respect to the entire image, and specify the size of the object's image by converting the area size into a pixel size.

In some of the foregoing examples, the image size of an image obtained at the subject device 21 is used as a center value, and the sizes smaller or larger than this baseline image size are selected so as to determine multiple different image sizes. However, the embodiments are not limited to this.

For example, as possible variations of the set of image sizes, the multiple image sizes may include, besides the baseline image size obtained at the subject device 21, only the sizes smaller than the baseline image size or only the sizes larger than this image size. Note that the multiple image sizes are not required to include the same image size as the baseline image size obtained at the subject device 21. For example, multiple variations of the image size set may be prepared in advance, and the variation that includes the closest image size to the baseline image size obtained at the subject device 21 may be selected. Or, it is possible to specify only the largest or the smallest image size for the multiple image sizes at first, and subsequently set the image sizes at random during the training process so as to determine the multiple different image sizes. For example, a variation may be determined so that the size that most matches the changes of the layer number of the network structure is included.

Note that the example shown in FIGS. 2A and 2B has assumed the conversion associated with the receptive field for the whole scalable network. However, the receptive field for the range of each processing stage (e.g., the later described first to third stages) may instead be assumed. Moreover, the conversion into the image size may utilize linear conversion or proportional conversion of the area corresponding to the receptive field.

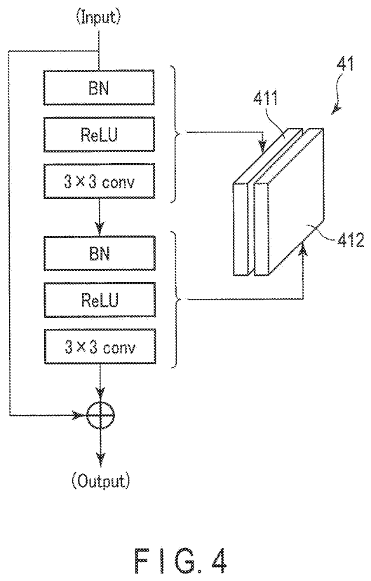

Next, FIGS. 4 to 6 will be referred to for explaining the concept of the scalable network training method according to one embodiment.

FIG. 4 is a conceptual diagram of a residual block of a ResNet adopted as the scalable network according to the embodiment. In the embodiment, a residual block 41 is a set of two processing blocks, namely, a first processing block 411 and a second processing block 412. The first processing block 411 and the second processing block 412 each include a batch normalization layer, a rectified linear unit (ReLU) layer, and a convolutional layer for a 3×3 kernel size. In the residual block 41, input data is processed in each layer of the first processing block 411. An output from the first processing block 411 is input to the second processing block 412 and subjected to convolutional processing. An output from the second processing block 412 and the input data coming from a shortcut connection together constitute the output from the residual block 41.

Note that the embodiments are not limited to the residual block 41 of the structure shown in FIG. 4. The residual block 41 may include a further convolutional layer, etc. Also, the order and the number of the batch normalization layer and the ReLU layer may be discretionarily changed. The embodiments are not limited to the batch normalization technique, either. Other regularization techniques such as the “Dropout” technique may instead or additionally be used. Further, the use of ReLU is not a limitation, and other activation functions such as a sigmoid function may instead or additionally be used.

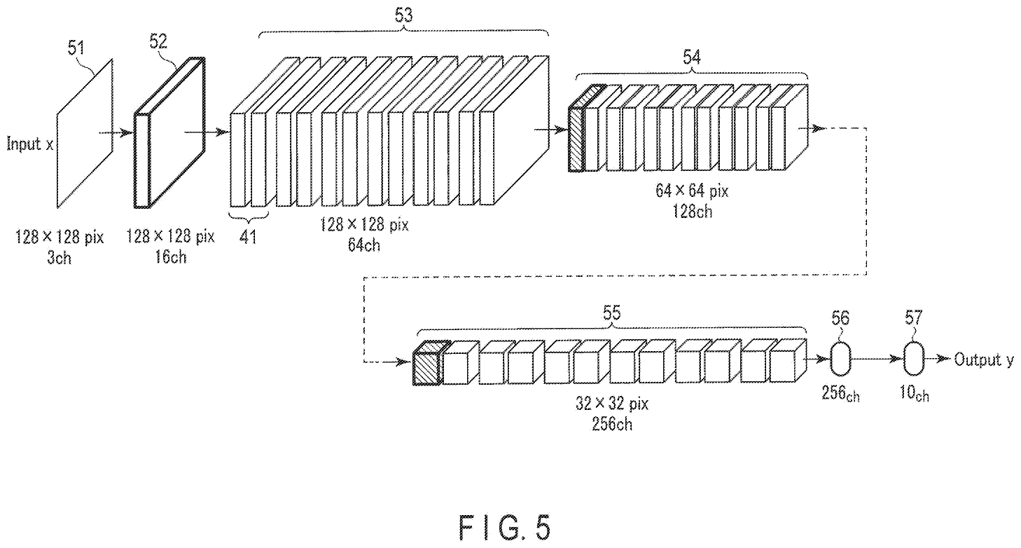

FIG. 5 is a conceptual diagram showing a layer structure of the scalable network, which is the basic structure (n=6).

The scalable network shown in FIG. 5 includes processing stages of residual blocks, namely, a first stage 53, a second stage 54, and a third stage 55. Each processing stage is constituted by one or more residual blocks 41 for performing intended processing for the same image size. Here, the number n is indicative of the number of the residual blocks 41 in each of the first stage 53, the second stage 54, and the third stage 55. That is, each of the first stage 35 to the third stage 55 in this structure includes 6 residual blocks 41.

For the example shown in FIG. 5, an input image 51 having a size of 128×128 [pixel] and three channels is assumed.

There is a convolutional layer 52 for performing convolutional processing based on a 3×3 kernel size. The input image 51 is input to the convolutional layer 52 and subjected to the convolutional processing, so that the number of channels is increased from 3 [ch] to 16 [ch].

In the first stage 53, an image of 128×128 [pixel] and 64 [ch] is generated in each residual block 41 and then passed to the subsequent stage as an input. In the initial residual block 41 of the first stage 53, an output from the convolutional layer 52 is used as an input to generate intermediate data having a channel number 64 [ch], increased from the channel number 16 [ch], through the batch normalization layer, the ReLU layer, and the convolutional layer for a 1×1 kernel size. This intermediate data is routed through a shortcut connection and added to the output from the second processing block 412 of the initial residual block 41.

In the second stage 54, an output from the first stage 53 is used as an input to the initial residual block 41, where it is processed through the batch normalization layer and the ReLU layer and subjected to the convolutional processing with a 1×1 kernel size and a stride of 2. This changes the image size from 128×128 [pixel] to 64×64 [pixel], and also the channel number from 64 [ch] to 128 [ch]. The remaining residual blocks 41 in the second stage 54 each process intermediate data having an image size of 64×64 [pixel] and a channel number of 128 [ch].

In the third stage 55, an output from the second stage 54 is used as an input to the initial residual block 41, where it is processed through the batch normalization layer and the ReLU layer and subjected to the convolutional processing with a 1×1 kernel size and a stride of 2. This changes the image size from 64×64 [pixel] to 32×32 [pixel], and also the channel number from 128 [ch] to 256 [ch]. The remaining residual blocks 41 in the third stage 55 each process intermediate data having an image size of 32×32 [pixel] and a channel number of 256 [ch].

There is a pooling layer 56 in which an output from the third stage 55 is subjected to batch normalization and ReLU application, and then to global average pooling.

Intermediate data output from the pooling layer 46 is subjected to full connection processing in a fully connected layer 57 and changes the channel number from 256 [ch] to 10 [ch]. The fully connected layer 57 gives an output y which also serves as an output from the scalable network. Note that the example shown in FIG. 5 assumes a multi-class classification problem for 10 classes. Accordingly, in the output y, the 10-dimensional vector is normalized by a softmax function so that the elements are each a non-negative value and together make a sum of 1, while each representing a probability. When dealing with such multi-class classification problems for classification into three or more classes, the sigmoid function and binary cross entropy as used in the above expression (2) may be replaced by a softmax function and cross entropy.

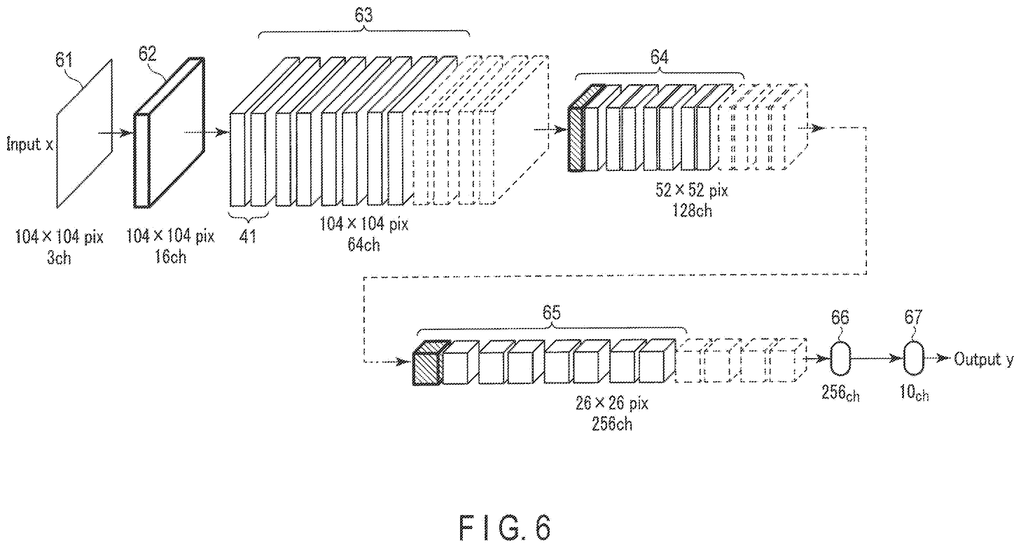

Next, FIG. 6 as a conceptual diagram showing a layer structure of the scalable network in the case of n=4 will be referred to. For the example shown in FIG. 6, an input image 61 having a size of 104×104 [pixel] is assumed. Here, the image size is smaller than that of the example shown in FIG. 5, and accordingly, the processing stages in the instant scalable network, namely, a first stage 63, a second stage 64, and a third stage 65, include a smaller number of residual blocks 41. More specifically, each of the first stage 63 to the third stage 65 includes 4residual blocks 41. The determiner 102 may adjust the layer number corresponding to the depth direction of the neural network as above, according to the layer number of the determined network structure and the size of the input image.

Processing may proceed in a manner similar to the processing discussed with reference to FIG. 5, except in the respect related to the different image sizes. More specifically, an input image 61 is processed in a convolutional layer 62 to increase the channel number to 16 [ch], and intermediate data of 104×104 [pixel] and 64 [ch] is processed in the 4 residual blocks 41 in the first stage 63. Likewise, processing may proceed so that intermediate data of 52×52 [pixel] and 128 [ch] is processed in the 4 residual blocks 41 in the second stage 64, and intermediate data of 26×26 [pixel] and 256 [ch] is processed in the 4 residual blocks 41 in the third stage 65.

FIG. 6 shows the example where the value of n is smaller than that of the basic structure (n=6), but a similar explanation is also applicable to the cases where the value of n is larger than that of the basic structure. For example, while not shown in the drawings, a case of n=8 may use first to third stages each including 8 residual blocks 41. Then, processing may proceed so that intermediate data of 152×152 [pixel] and 64 [ch] is processed in the first stage, intermediate data of 76×76 [pixel] and 128 [ch] is processed in the second stage, and intermediate data of 38×38 [pixel] and 256 [ch] is processed in the third stage.

Note that the structures of the scalable network shown in FIGS. 5 and 6 may each be substituted by any network structure provided that such a structure can adjust the layer number according to image sizes, that is, provided that such a structure increases the layer number (deepens the layer structure) for a larger image size and decreases the layer number (shallows the layer structure) for a smaller image size. While the examples shown in FIGS. 5 and 6 assume fixed channel numbers and fixed kernel sizes for hidden layers, the determiner 102 may, in addition to changing the layer number of the network, change the channel numbers or the kernel sizes in proportion to the image size. For example, a larger kernel size may be set for a larger image size, and a smaller kernel size may be set for a smaller image size.

Further, the trainer 103 may also generate a trained model by iteratively training a scalable network, which is adapted to change the size of input data (image), with data of multiple images having mutually different image sizes as inputs, while keeping the network structure and the layer number unchanged.

Also, while the foregoing examples have assumed structures of the scalable network for a classification task, the embodiments are not limited to these but may assume a segmentation task, a regression task, etc. For such a regression task, the expression (2) may use, for example, a mean squared error (MSE) or a mean absolute error (MAE) in place of a sigmoid function.

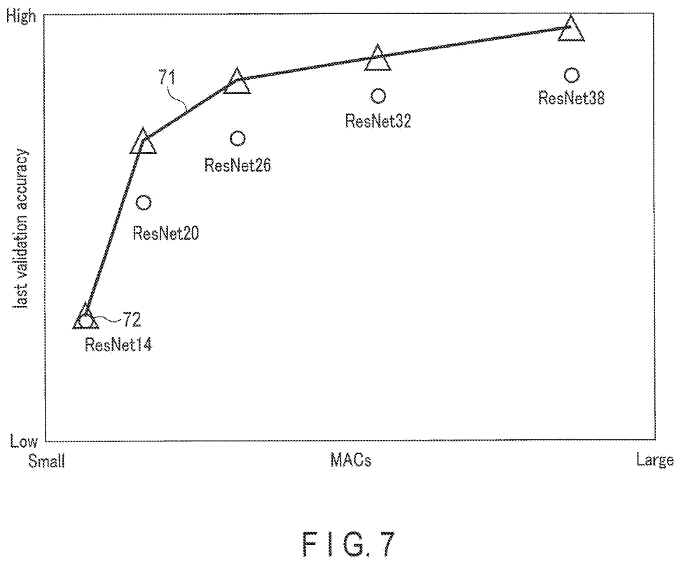

FIG. 7 shows the results of simulation with the trained model formed from the scalable network trained by the learning apparatus 10 according to the embodiment, and also with trained model formed from the conventional neural network with a fixed image size and a fixed layer number.

The horizontal axis represents a number of multiplications performed for the inference (processing) of one image, and thus, has the same meaning as a calculation cost. Fewer multiplications, i.e., a smaller value in the horizontal axis, indicate a higher inference ability. The vertical axis represents an accuracy rate of a test sample, and thus, has the same meaning as an inference accuracy.

The inference results given by the scalable network according to the embodiment are shown by a graph 71, while the inference results given by the conventional neural network are shown by plotted points 72. By comparison at the same calculation cost, a higher accuracy rate is demonstrated by the graph 71 than the plotted points 72. It is therefore understood that, as shown in FIG. 7, the scalable neural network that undergoes a training process with combinations of different data resolutions and different layer numbers as a single model can realize inference with an enhanced accuracy at the same calculation cost as that of the conventional neural network that undergoes a training process with one data resolution and one layer number.

Note that when there are multiple subject devices 21 differing from one another in data resolution of the respective subject data, the determiner 102 may determine the variations of the data resolutions and the layer numbers based on the device information of each subject device 21.

For example, the determiner 102 may first determine the basic structures corresponding to the respective subject devices 21 in the manner as described above, then determine the smallest and the largest basic structures among them, and select M combinations of the image size and the layer number within a range covering the smallest and the largest basic structures.

In more concrete terms, it will be supposed that the image size and the basic structure for the first subject device are 128 [pixel] and n=5, those for the second subject device are 64 [pixel] and n=3, and those for the third subject device are 160 [pixel] and n=6. Here, the basic structure n=3 is the smallest, and the basic structure n=6 is the largest. Thus, the variation of the data resolution set may be set to include an image size even smaller than the corresponding smallest image size and an image size even larger than the corresponding largest image size. For example, by adopting the image sizes S={32, 64, 96, 128, 160, 192} and the layer numbers n={2, 3, 4, 5, 6, 7}, the scalable network can be trained based on the variation that covers the smallest and the largest basic structures. The trained model that has undergone the training process applied with conditions of such image sizes and layer numbers is a neural network capable of accurately coping with each of these image sizes and layer numbers, and as such, the trained model can provide parameters for the basic structures corresponding to the respective devices.

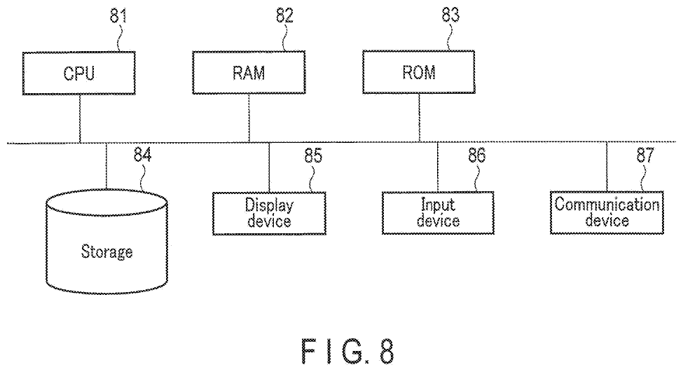

Next, FIG. 8 will be referred to for explaining an exemplary hardware configuration of the learning apparatus 10 according to the foregoing embodiments.

The learning apparatus 10 includes a central processing unit (CPU) 81, a random access memory (RAM) 82, a read only memory (ROM) 33, a storage 84, a display device 85, an input device 86, and a communication device 87, which are connected to one another via a bus.

The CPU 81 is a processor adapted to execute arithmetic operations and control operations according to one or more programs. The CPU 81 uses a prescribed area in the RAM 82 as a work area to perform, in cooperation with one or more programs stored in the ROM 83, the storage 84, etc., operations of the components of the learning apparatus 10 including the acquirer 101, the determiner 102, the trainer 103, and the provider 104.

The RAM 82 is a memory which may be a synchronous dynamic random access memory (SDRAM). The RAM 82, as its function, provides the work area for the CPU 81. Meanwhile, the ROM 83 is a memory that stores programs and various types of information in a manner that no rewriting is permitted.

The storage 84 is one or any combination of storage media including a magnetic storage medium such as a hard disc drive (HDD) and a semiconductor storage medium such as a flash memory. The storage 84 may be an apparatus adapted to perform data write and read operations with a magnetically recordable storage medium such as an HDD and an optically recordable storage medium. The storage 84 may conduct data write and read operations with storage media under the control of the CPU 81.

The display device 85 may be a liquid crystal display (LCD), etc. The display device 85 is adapted to present various types of information based on display signals from the CPU 81.

The input device 86 may be a mouse, a keyboard, etc. The input device 86 is adapted to receive information from user operations as instruction signals and send the instruction signals to the CPU 81.

The communication device 87 is adapted to communicate with external devices under the control of the CPU 81.

According to the embodiments described above, subject data obtained at a subject device, which is an intended recipient of a trained model, is referred to for determining mutually different multiple data resolutions that will constitute training samples for training a scalable network. The scalable network here is adapted to change at least the data resolutions of input data. The scalable network undergoes an iterative training process with the training samples corresponding to the multiple different data resolutions so that the trained model to be provided to the subject device is generated. Thus, as described above, efficient and effective training conditions can be set by selecting various resolutions around the subject data resolution based on the specification, etc. of a subject device and by determining a variation of the training samples for training the network accordingly. Consequently, a highly accurate trained model can be provided for the subject device.

Instructions in the processing steps described for the foregoing embodiments may follow a software program. It is also possible for a general-purpose computer system to store such a program in advance and read the program to realize the same effects as provided through the control of the learning apparatus described above. The instructions described in relation to the embodiments may be stored as a computer-executable program in a magnetic disc (flexible disc, hard disc, etc.), an optical disc (CD-ROM, CD-R, CD-RW, DVD-ROM, DVD±R, DVD±RW, Blu-ray (registered trademark) disc, etc.), a semiconductor memory, or a similar storage medium. The storage medium here may utilize any storage technique provided that the storage medium can be read by a computer or by a built-in system. The computer can realize the same behavior as the control of the learning apparatus according to the above embodiments by reading the program from the storage medium and, based on this program, causing the CPU to follow the instructions described in the program. Of course, the computer may acquire or read the program via a network.

Note that the processing for realizing each embodiment may be partly assigned to an operating system (OS) running on a computer, database management software, middleware (MW) of a network, etc., according to an instruction of a program installed in the computer or the built-in system from the storage medium.

Further, each storage medium for the embodiments is not limited to a medium independent of the computer and the built-in system. The storage media may include a storage medium that stores or temporarily stores the program downloaded via a LAN, the Internet, etc.

The embodiments do not limit the number of the storage media to one, either. The processes according to the embodiment may also be conducted with multiple media, where the configuration of each medium is discretionarily determined.

The computer or the built-in system in the embodiments is intended for use in executing each process in the embodiments based on one or more programs stored in one or more storage media. The computer or the built-in system may be of any configuration such as an apparatus constituted by a single personal computer or a single microcomputer, etc., or a system in which multiple apparatuses are connected via a network.

Also, the embodiments do not limit the computer to a personal computer. The “computer” in the context of the embodiments is a collective term for a device, an apparatus, etc., which are capable of realizing the intended functions of the embodiments according to a program and which include an arithmetic processor in an information processing apparatus, a microcomputer, and so on.

While certain embodiments have been described, they have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims arid their equivalents are intended to cover such forms or modifications as would fall within the scope and spirit of the inventions.

What is claimed is:

1. A learning apparatus comprising a processor configured to:
determine, based on a data resolution of subject data obtained at a subject device, a plurality of data resolutions that differ from one another within a range covering the data resolution of the subject data, the data resolutions each indicating a corresponding amount of information per unit; and
train a scalable network with training samples corresponding to each of the plurality of data resolutions, the scalable network being a neural network adapted to change a data resolution of input data.

2. The apparatus according to claim 1, wherein the processor determines, as a basic structure, a structure of the scalable network corresponding to the data resolution of the subject data, and
determines, based on a layer number of the basic structure, layer numbers of the scalable network in proportion to each data resolution.

3. The apparatus according to claim 2, wherein the processor determines the basic structure based on a specification of the subject device, and
determines the plurality of data resolutions according to changes in receptive field for convolutional processing that accompany changes in the layer numbers.

4. The apparatus according to claim 3, wherein the specification is at least one of a capacity of a memory of the subject device, processing ability of a processor of the subject device, and power consumption of the subject device.

5. The apparatus according to claim 1, wherein the processor is further configured to provide a trained model to the subject device, the trained model being the scalable network trained based on a basic structure of the scalable network that corresponds to the data resolution of the subject data.

6. The apparatus according to claim 1, wherein the processor trains the scalable network upon changing at least one of a layer number, a channel number, and a kernel size for convolutional processing, in proportion to the plurality of data resolutions.

7. The apparatus according to claim 1, wherein the subject data is image data, and the plurality of data resolutions are mutually different multiple image sizes, and
wherein the processor determines the mutually different multiple image sizes from a size of an object in the image data.

8. The apparatus according to claim 7, wherein the processor determines the size of the object in the image data, from a label in target data or a bounding box for object detection.

9. The apparatus according to claim 7, wherein the processor determines the size of the object in the image data, from a spatial relationship between the object and the subject device.

10. The apparatus according to claim 7, wherein the processor determines the size of the object in the image data, using a classification result and a saliency map obtained by inputting the image data to other trained model.

11. The apparatus according to claim 1, wherein the processor subjects the scalable network to mini-batch training with a plurality of training samples corresponding to the plurality of data resolutions assigned to one batch.

12. The apparatus according to claim 1, wherein the processor uses individual normalization layers in network structures of the scalable network corresponding to the plurality of data resolutions, respectively.

13. The apparatus according to claim 1, wherein
the processor determines the plurality of data resolutions in such a manner that the plurality of data resolutions include each of the data resolutions of the subject data obtained at a plurality of subject devices, respectively.

14. A learning method comprising:
determining, based on a data resolution of subject data obtained at a subject device, a plurality of data resolutions that differ from one another within a range covering the data resolution of the subject data, the data resolutions each indicating a corresponding amount of information per unit; and
training a scalable network with training samples corresponding to each of the plurality of data resolutions, the scalable network being a neural network adapted to change a data resolution of input data.

15. A computer readable medium including computer executable instructions, wherein the instructions, when executed by a processor, cause the processor to perform a learning method comprising:
determining, based on a data resolution of subject data obtained at a subject device, a plurality of data resolutions that differ from one another within a range covering the data resolution of the subject data, the data resolutions each indicating a corresponding amount of information per unit; and
training a scalable network with training samples corresponding to each of the plurality of data resolutions, the scalable network being a neural network adapted to change a data resolution of input data.
